(19) United States
(12) Patent Application Publication
(10) Pub. No.: US 2004/0114874 A1
(43) Pub. Date: Jun. 17, 2004

(54) Optical fiber array devices and methods of manufacture

(76) Inventors: Katsumi Bono, Tokyo (JP); Alfredo D. Botet, Painted Post, NY (US); Minoru Yagi, Tokyo (JP)

Correspondence Address: CORNING INCORPORATED, SP-TI-3-1, CORNING, NY, 14831

(21) Appl. No.: 10/319,041

(22) Filed: Dec. 12, 2002

(51) Int. Cl. G02B 6/00

(52) U.S. Cl. 385/53

(57) ABSTRACT

Devices and methods for interconnecting optical devices having different pitches are disclosed. The devices and methods include optical fiber gripping elements on a substrate. The gripping elements are adapted to secure arrays of optical fibers having different pitches between ends of the substrate.

### FIELD OF THE INVENTION

This invention relates to optical fiber arrays and devices including optical fiber arrays.

### BACKGROUND OF THE INVENTION

Integrated optical waveguide circuit devices, including planar waveguides, lightwave optical circuits, and optical devices on planar glass and semiconductor substrates are becoming increasingly important in multi-wavelength transmissions systems and optical telecommunications systems. To function, a light guiding waveguide region in one optical device must be interconnected or pigtailed with a light guiding waveguide region in an optical fiber. Optical fiber arrays or ribbons are usually interconnected with planar optical devices by supporting the optical fibers thereof between two support members made of a crystalline material, such as silicon. The support members have V-grooves formed therein utilizing photolithographic masking and etching techniques. The optical fibers are placed side by side in individual V-grooves of one support member and the other mating support member having corresponding V-grooves is placed over the fibers to bind or hold the fibers in a precision, spatial relationship between the mating V-grooves. The top and bottom support members sandwiching the optical fiber ribbon are typically bonded together with a clamp or adhesive, forming a connector. A connector may then be placed in an abutting relationship with a planar optical device so that the ends of the optical fibers of the connector are substantially co-axially aligned with the waveguides in the planar optical device.

In integrated optical devices, the pitch or the spacing between waveguides of the individual optical devices is often different. Single V-groove connectors cannot be used to connect two optical devices having a different waveguide pitch since it is not possible to change the spacing between grooves' due to the crystallographic nature of the material. It would be desirable to provide devices and methods that enable the pitch conversion on a single substrate to connect optical devices having different waveguide pitches. Such devices and methods would facilitate the manufacture of a wide variety of optical devices.

### SUMMARY

The various embodiments of the invention relate to methods and devices for positioning arrays of optical fibers and for connecting optical devices having different pitches. The devices and methods include a substrate having a plurality of optical fiber gripping elements adapted to hold arrays of optical fibers. The pitch of the gripping elements is varied across the surface of the substrate. It is to be understood that both the foregoing general description and the following detailed description are exemplary and are intended to provide further explanation of the invention as claimed.

### BRIEF DESCRIPTION OF THE DRAWINGS

FIG. 1 is an exploded perspective view of a device for holding an array of fibers according to one embodiment of the invention which can be used optically couple two optical devices including waveguides that have a different waveguide pitch;

FIG. 2 is an edge view of a gripping element according to one embodiment of the invention; and

FIG. 3 is an edge view of a gripping element including an optical fiber disposed between a groove of the gripping element according to one embodiment of the invention.

### DETAILED DESCRIPTION

Before describing several exemplary embodiments of the invention, it is to be understood that the invention is not limited to the details of construction or process steps set forth in the following description. The invention is capable of other embodiments and of being practiced or carried out in various ways.

The various embodiments of the present invention provide devices and articles for securing arrays of optical fibers on a substrate at varying pitches. According to certain embodiments of the methods and articles of the present invention are useful for connecting planar waveguide devices having different waveguide pitches. The devices for securing arrays of fibers and the planar waveguides can all be arranged on a common substrate or on multiple substrates.

U.S. Pat. Nos. 6,266,472 and 5,359,687, both of which are incorporated herein by reference, describe polymer microstructures and methods of manufacturing such microstructures for gripping optical fibers. In U.S. Pat. No. 5,359,687, the polymer microstructures formed on a substrate are used to grip optical fibers and position these fibers with respect to a waveguide disposed on the substrate. U.S. Pat. No. 6,266,472 discloses polymer gripping elements that are used in splicing optical fibers.

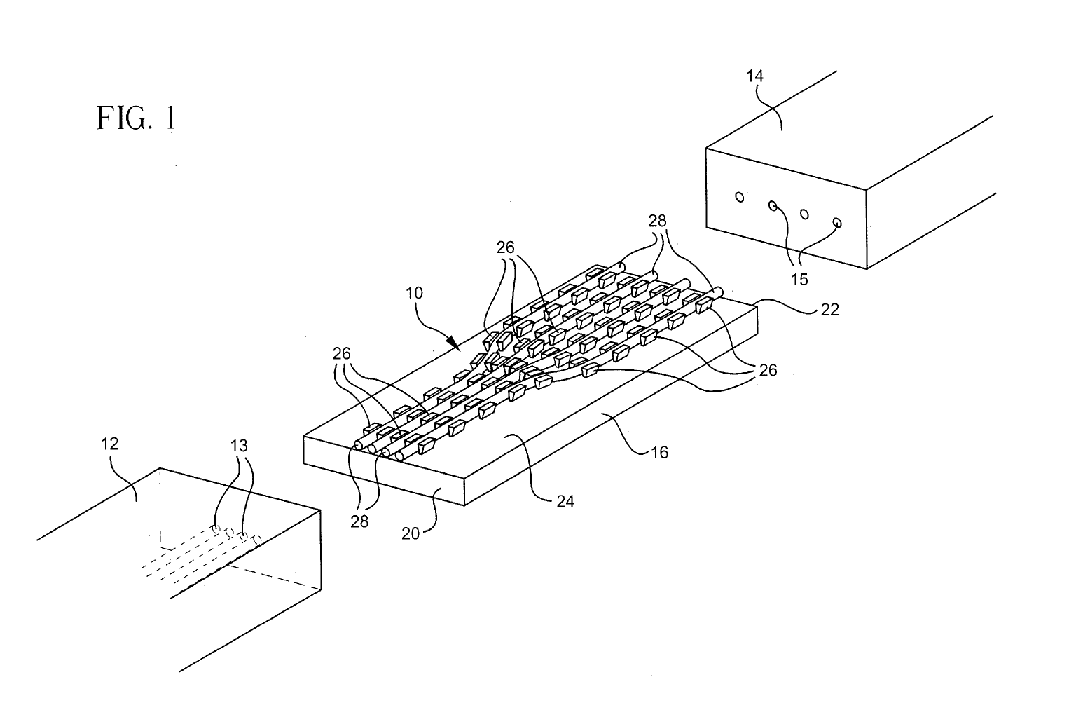

Referring now to FIG. 1, an optical fiber holding device 10 which can be used for connecting optical devices 12, 14 together is shown according to an exemplary embodiment of the present invention. The optical devices 12, 14 that can be optically connected together include but are not limited to planar optical devices that include waveguide regions 13, 15. It will be understood, however, that the invention is not limited to the connection of planar devices, and in certain embodiments, the devices of the present invention can be used to connect arrayed optical fibers having varying pitches. According to certain embodiments of the invention, the waveguides 13 in one optical device 12 have pitch that is different from the pitch of the waveguides 15 in the other optical device 14. As used herein, pitch means the distance between the waveguide centers.

The optical fiber holding device 10 includes a substrate 16 having a first end 20, a second end 22, and a mounting surface 24. A plurality of flexible optical fiber gripping elements 26 are included on the mounting surface 24 of the substrate 16 for securing an array of optical fibers 28 to the substrate 16. The array of optical fibers has a pitch that varies between the two ends 20, 22. According to one embodiment of the invention, the pitch of the array of fibers on the end 20 of the substrate 16 is equivalent to the pitch of the waveguides 13 in the optical device 12, and the pitch of the array of fibers on the end 22 of the substrate 16 is matched to the pitch of the waveguides 15 in the optical device 14.

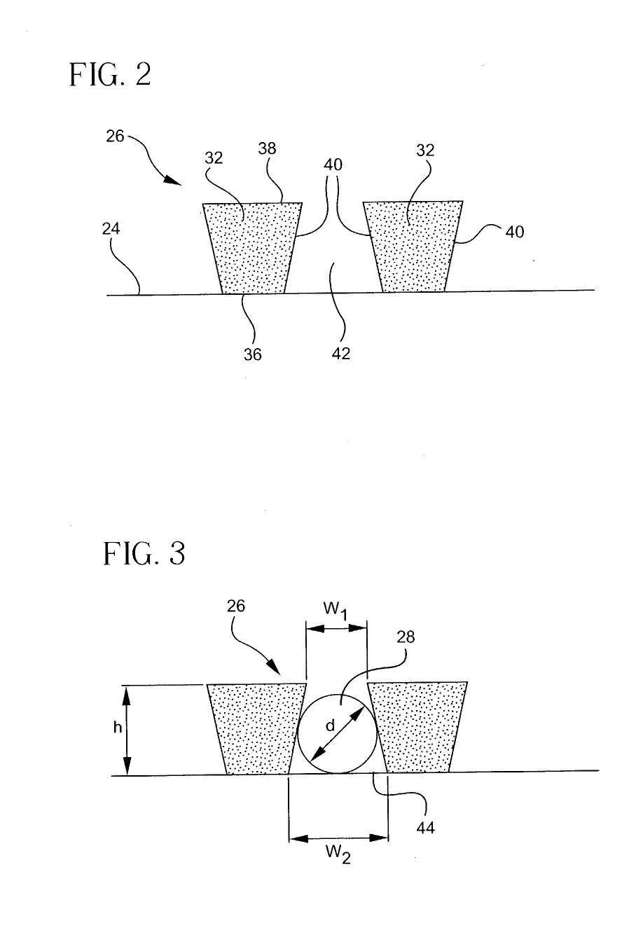

FIG. 2 shows a gripping element 26 in more detail. Each gripping element 26 includes laterally spaced flexible strips 32 attached to the surface of a substrate 24. Each of the flexible strips 26 has a base portion 36 attached to a surface of the substrate 24, a top surface 38 which is preferably substantially parallel with the surface of the substrate 24 and sidewalls 40. A pair of sidewalls 40 provides a groove 42 between the strips 32 sized to hold optical fiber. A portion of the substrate 24 forms a floor of the groove 42. According to certain embodiments the flexible strips have a generally trapezoidal cross-section.

Referring now to FIG. 3, a portion of the substrate surface 24 forms a floor 44 for the gripping element so that the groove has a width near the floor w₂ that is greater than the width w₁ at the top of the groove. Preferably, to adequately grip the surface of a fiber, the width w₁ at the top of the groove is less than the diameter d of the fiber. The width w₂ at the bottom of the groove is preferably greater than the diameter d the fiber. It will be understood that fibers having a larger diameter, for example coated fibers versus uncoated fiber, will require a larger groove to accept insertion of the fiber and to hold the fiber in place vertically and horizontally along its axis. The sidewalls of each strip should be sufficiently flat so that each strip contacts the fiber at least at one point so that the gripper exerts a force on the fiber generally perpendicular to the fiber axis. U.S. Pat. No. 5,359,687 contains additional details on particular dimensions for common telecommunications fibers.

The strips that make up the gripping elements are formed using well-known lithographic processes using photopolymerizable compositions and the like. For example, a photopolymerizable composition can be substantially uniformly deposited on onto a substrate surface. The photopolymerizable composition is then imagewise exposed to actinic radiation using a laser and a computer-controlled stage to expose precise areas of the composition with an ultraviolet laser beam, or a collimated UV lamp together with a photomask having a pattern of substantially transparent and substantially opaque areas. The nonimaged areas can then be removed with solvent, while leaving the imaged areas in the form of at least one gripping element on the substrate surface.

Alternatively, flexible strips can be formed by using a soft, flexible embossing tool to pattern the polymerizable composition in the form of at least one gripping element on the substrate surface. Such soft tooling is commonly made with silicones. The composition is then cured and the tool is removed. The flexibility of the tool must be sufficient so that it can be removed from the cured polymer without damaging the grippers. The polymerizable composition may be cured by various means such as actinic radiation or heat, and should have the viscosity to conform to the raised features of the tool. After removing the tool from the cured composition, at least one gripping element will remain on the substrate, depending on the nature of the pattern. The pattern of the tool may include a plurality of gripping elements to provide a substrate for aligning an array of fibers. Suitable polymeric compositions for making the gripping elements are disclosed in commonly assigned U.S. Pat. No. 6,266,472.

The articles and methods are useful for positioning opposing optical devices including waveguides that have different pitches. The opposing optical devices as well as the optical fibers can be positioned on a common substrate or on different substrates. Although FIG. 1 shows a device in which a 1×N array of fibers is used to connect two optical devices having arrays of 1×N waveguides, it will be understood that stacked fiber arrays could be used to connect 2×N, 3×N and larger stacked arrays.

The use of flexible gripping elements to position fibers in an array enables a wide variety of array configurations. Silicon v-groove technology limits the number of configurations that can be used to position fibers in an array because silicon v-grooves are constrained by the crystallographic planes of the material to achieve the v-shaped grooves in a silicon substrate. The v-grooves can only be formed in a parallel configuration. The gripping elements of the present invention allows for greater flexibility in providing a wider variety of fiber arrangements, such as curved configuration, increasing or decreasing pitch along the surface of a substrate, and angled configurations.

In use, the fiber holding and connecting devices can be used to connect a variety of optical devices together. Thus, a device including a substrate and a plurality of flexible gripping elements for securing an array of optical fibers to the substrate can be configured such that the array of fibers has a pitch that varies between the two ends of the substrate. Individual fibers are secured in the gripping elements, and a first optical device is connected to a first end of the substrate, and a second optical device is connected to a second end of the substrate.

The devices and methods of the present invention can be used to connect a variety of devices to multi-fiber ribbons and arrays. Multi-fiber ribbons and connectors have numerous applications in optic communication systems. For example, some optoelectronic and optical application specific integrated circuits (OASIC) devices, such as optical switches, arrayed waveguide gratings, multiplexers, demultiplexers, optical power splitters/combiners, and routers, have several input and/or output ports arranged as linear arrays to which a plurality of fibers are to be coupled. Since optical fibers are attached to launch optical signals into these devices and extract optical signals out of these devices, splicing of arrays of fibers to such devices can be achieved using multifiber connectors of the present invention

It will be apparent to those skilled in the art that various modifications and variations can be made to the present invention without departing from the spirit or scope of the invention. For example, the size of the gripping elements can be varied to connect fibers having varying diameters. Thus, it is intended that the present invention cover modifications and variations of this invention provided they come within the scope of the appended claims and their equivalents.

What is claimed is:

1. An optical fiber holding device comprising:
a substrate having a first end and a second end; and
a plurality of flexible optical fiber gripping elements on the substrate for securing an array of optical fibers to the substrate, the array of fibers having a pitch that varies between the two ends of the substrate.

2. The device of claim 1, wherein each gripping element includes a pair of flexible side walls defining a groove therebetween sized to hold an optical fiber.

3. The device of claim 1, wherein the flexible sidewalls of the gripping element are comprised of a polymer.

4. The device of claim 3, wherein the sidewalls of the fiber gripping element are generally parallel.

5. The device of claim 4, wherein the gripping elements have a generally trapezoidal cross-section.

6. A device for connecting two optical devices together comprising:
a substrate having a first end and a second end;
a plurality of flexible optical fiber gripping elements on the substrate adapted to secure an array of optical fibers to the substrate, the pitch of the array on the first end of the substrate being different than the pitch of the array on the second end of the substrate.

7. The device of claim 6, wherein each gripping element includes a pair flexible side walls defining a groove therebetween sized to hold an optical fiber.

8. The device of claim 6, wherein the flexible sidewalls of the gripping element are comprised of a polymer.

9. The device of claim 8, wherein the sidewalls of the fiber gripping element are generally parallel.

10. The device of claim 9, wherein the gripping elements have a generally trapezoidal cross-section.

11. A method of interconnecting optical devices having different pitches comprising:
providing a substrate having two ends and a plurality of flexible gripping for securing an array of optical fibers to the substrate, the array of fibers having a pitch that varies between the two ends;
connecting a first optical device to a first end of the substrate; and
connecting a second optical device to a second end of the substrate.

12. The method of claim 11, wherein the pitch at the first end of the substrate is different from the pitch at the second end of the substrate.
